(19) United States
(12) Patent Application Publication
(10) Pub. No.: US 2026/0312321 A1
(43) Pub. Date: Oct. 8, 2026

(54) ELECTRICAL CONNECTOR WITH IMPROVED TERMINALS

(71) Applicant: FOXCONN INTERCONNECT TECHNOLOGY LIMITED, Grand Cayman (KY)

(72) Inventors: FANG-JWU LIAO, New Taipei (TW); CHI-HSIANG LU, New Taipei (TW); JIA-HAU LIU, New Taipei (TW); CHIA-RU CHANG, New Taipei (TW); MING-LUN SZU, New Taipei (TW); CHIA-LING FAN, New Taipei (TW)

(21) Appl. No.: 19/635,730

(22) Filed: Mar. 31, 2026

Related U.S. Application Data
(63) Continuation-in-part of application No. 19/351,532, filed on Oct. 7, 2025.

(30) Foreign Application Priority Data
Apr. 2, 2025 (TW) 114112700
May 21, 2025 (TW) 114119126

(51) Int. Cl. H01R 13/24; H01R 12/70; H01R 12/71; H01R 13/422

(52) U.S. Cl. CPC H01R 13/2464; H01R 12/7082; H01R 12/714; H01R 13/4223

(57) ABSTRACT

An electrical connector including an insulating housing, and plural terminal grooves penetrating the insulating housing; and plural terminals retained in corresponding terminal grooves respectively, wherein each terminal includes a retaining portion fixed in the terminal groove, an upper elastic arm extending upward from the retaining portion and having an arc-shaped upper elastic portion, a lower elastic arm extending downward from the retaining portion and having an arc-shaped lower elastic portion, and a touching portion extending forward from the retaining portion, each of the upper elastic portion and the lower elastic portion has a first slot and arcs backward, the touching portion is split from the first slot of the upper elastic portion or the lower elastic portion, and the upper elastic arm and the lower elastic arm are moveable to abut against the touching portion when the upper elastic arm and the lower elastic arm are pressed.

### CROSS REFERENCE TO RELATED APPLICATIONS

This application is a continuation-in-part of U.S. patent application Ser. No. 19/351,532, filed on Oct. 7, 2025, the content of which is incorporated entirely herein by reference.

### BACKGROUND OF THE INVENTION

### Field of the Invention

The present invention relates to an electrical connector.

### Description of Related Arts

U.S. Pat. No. 11,349,244 discloses an electrical connector having plural electrical contacts. The electrical contact includes an outer part and an inner part linked by a bridge. The outer part includes a retention section, a resilient upper contacting arm extending from the retention section with an upper mating apex and an upper abutment tip region, and a resilient lower contacting arm extending from the retention section with a lower mating apex and a lower abutment tip region. An upper abutment tab and a lower abutment tab extends upwardly and downwardly respectively from the retention section. The upper abutment tip region contacts with the upper abutment tab and the lower abutment tip region contacts with the lower abutment tab when the terminal is pressed.

Therefore, it is desired to provide an electrical connector with improved terminals.

### SUMMARY OF THE INVENTION

An object of the present invention is to provide an electrical connector with improved terminals.

To achieve the above object, an electrical connector comprises an insulating housing having an upper face, a lower face, and a plurality of terminal grooves penetrating the upper face and the lower face in an upper-lower direction; and a plurality of terminals retained in corresponding terminal grooves respectively; wherein each terminal includes a retaining portion fixed in the terminal groove, an upper elastic arm extending upward from the retaining portion and having an arc-shaped upper elastic portion, a lower elastic arm extending downward from the retaining portion and having an arc-shaped lower elastic portion, and a touching portion extending forward from the retaining portion, each of the upper elastic portion and the lower elastic portion has a first slot and arcs backward, the touching portion is split from the first slot of the upper elastic portion or the lower elastic portion, and the upper elastic arm and the lower elastic arm are moveable to abut against the touching portion when the upper elastic arm and the lower elastic arm are pressed.

Other advantages and novel features of the invention will become more apparent from the following detailed description of the present embodiment when taken in conjunction with the accompanying drawings.

### BRIEF DESCRIPTION OF THE DRAWING

FIG. 1 is a perspective view of an electrical connector of a first embodiment of this invention, wherein two terminals are separated from an insulating housing;

FIG. 2 is perspective view of the terminal in FIG. 1;

FIG. 3 is another perspective view of the terminal in FIG. 2;

FIG. 4 is a front view of the terminal in FIG. 2;

FIG. 5 is a side view of the terminal in FIG. 2;

FIG. 6 is a perspective view of the terminal in FIG. 2 when the terminal is pressed;

FIG. 7 is another perspective view of the terminal in FIG. 6;

FIG. 8 is a side view of the terminal in FIG. 7;

FIG. 9 is a cross section view of the electrical connector taken along line A-A of FIG. 1;

FIG. 10 is a cross section view of the electrical connector in FIG. 9 when the terminal is pressed;

FIG. 11 is an enlarged perspective view of a part of the insulating housing viewed in an upper to lower direction, to show terminal grooves;

FIG. 12 is an enlarged perspective view of a part of the insulating housing viewed in lower to upper direction;

FIG. 13 is a side view of a terminal of a second embodiment when the terminal is pressed;

FIG. 14 is a perspective view of a terminal of a third embodiment;

FIG. 15 is a front view of the terminal in FIG. 14;

FIG. 16 is a side view of the terminal in FIG. 14;

FIG. 17 is a perspective view of the terminal when the terminal is pressed;

FIG. 18 is a side view of the terminal in FIG. 16 when the terminal is pressed;

FIG. 19 is a cross section view of an electrical connector in the third embodiment;

FIG. 20 is a cross section view of the electrical connector in FIG. 19 when the terminal is pressed; and

FIG. 21 is a perspective view of a terminal of a fourth embodiment.

### DETAILED DESCRIPTION OF THE PREFERRED EMBODIMENT

Reference will now be made in detail to the preferred embodiments of the present invention.

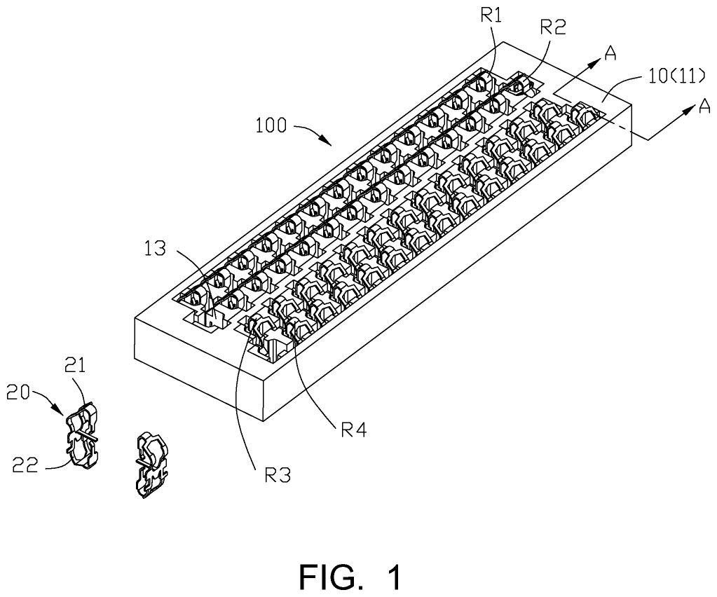

Referring to FIG. 1, an electrical connector 100 is used for electrically connecting an electrical module, e.g., a chip module, to a circuit board or connecting two circuit boards. The electrical connector 100 includes an insulating housing 10 and a plurality of terminals 20 arranged in a matrix. The insulating housing 10 is provided with an upper face 11, a lower face, and plural terminal grooves 13 penetrating the upper face 11 and the lower face. The terminals 20 are disposed in the terminal grooves 13 one by one. It should be noted that, in fact, the electrical connector 100 has hundreds of terminals. In the invention, only four rows of terminals 20 in the terminal grooves, namely, a first row of terminals R1, a second row of terminals R2, a third row of terminals R3 and a fourth row of terminals R4 are illustrated. Each row of terminals 20 is arranged along a first direction (i.e., a left-right direction shown in FIG. 1), and the first row R1 and the second row R2, the third row R3 and the fourth row R4 are arranged side by side along a second direction perpendicular to the first direction. Two adjacent rows of terminals are staggered along the first direction. As the first row of terminals R1 and the second row of terminals R2 are staggered along the first direction, the terminals 20 of the second row of terminals R2 are positioned directly opposite gaps between two adjacent terminals 20 in the first row of terminals R1, and likewise, the terminals 20 of the first row of terminals R1 are positioned directly opposite gaps between two adjacent terminals 20 in the second row of terminals R2.

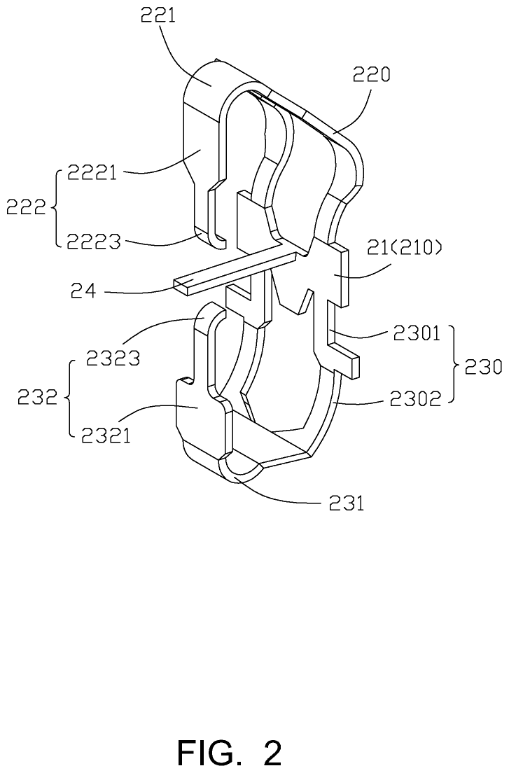

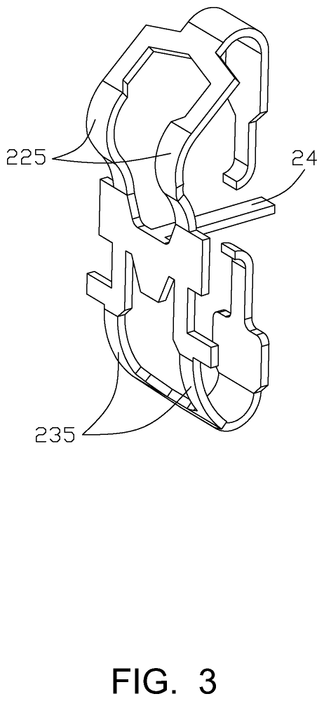

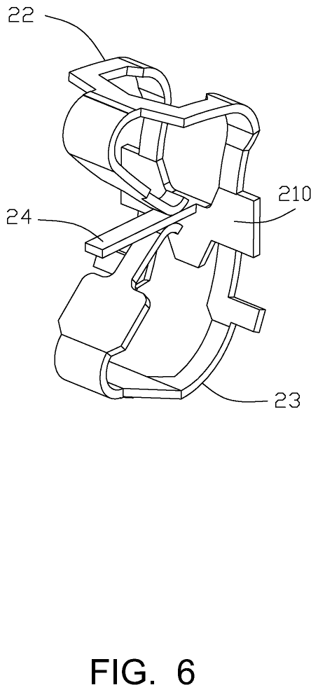

Combined with FIGS. 2-6, each terminal 20 includes a retaining portion 21 retained in the terminal groove 13, a first elastic arm/upper elastic arm 22 extending from the retaining portion 21 upward and a second elastic arm/lower elastic arm 23 extending from the retaining portion 21 downward respectively. The rows of terminals 20 are divided into two zones along the second direction, referred as a first zone and a second zone. All the elastic arms of the terminals 20 in the first zone extend along a same direction, namely, a first extending direction, and all the elastic arms of the terminals in second zone extend along another same direction, namely, a second extending direction, and the first extending direction is opposite to the second extending direction. Preferably, the elastic arms of the first row of terminals R1 and the second row R2 of terminals extend along the first extending direction, the elastic arms of the terminals 20 in the third row R3 and the fourth row R4 extend along the second extending direction. In actual products, the electrical connector 100 includes plural rows of terminals 20 arranged in the first direction and set side by side in the second direction, that is, there are dozens, even hundreds rows of terminals in both the first zone and the second zone. Preferably, there is a grounding shield between the first zone and the second zone, and the grounding shield is set between the second row of terminals R2 and the third row R3 of terminals.

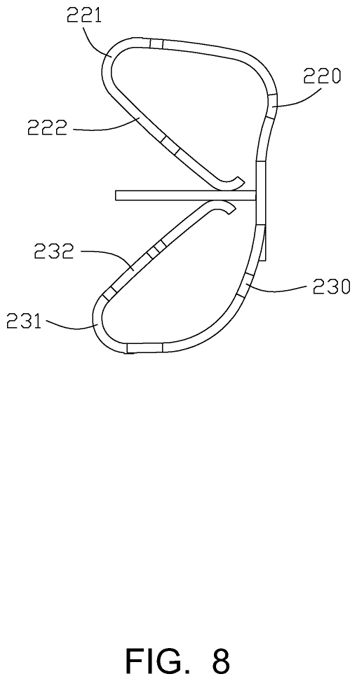

Referring to FIGS. 2-6, the retaining portion 21 includes a plate-shaped first vertical portion 210. The upper elastic arm 22 includes an upper elastic portion 220, an upper contacting portion 221 and an upper abutting portion 222, the lower elastic arm 23 includes a lower elastic portion 230, a lower contacting portion 231 and a lower abutting portion 232. The upper elastic portion 220 extends upward and forward from the first vertical portion 210, the lower elastic portion 230 extends downward and forward from the first vertical portion 210. The terminal 20 further includes a touching portion 24 extends horizontally forward from the retaining portion 21. Combined with FIG. 8, the upper abutting portion 222 and the lower abutting portion 232 abuts against the touching portion 24 when the upper elastic arm 22 and the lower elastic arm 23 are pressed.

In the embodiment, the upper elastic arms 22 and the lower elastic arm 23 are not symmetrically in an upper-lower direction. Preferably, a horizontal projection of one of the upper elastic portion 220 and the lower elastic portion 230 extends further rearward than that of the other, that is, the upper elastic portion 220 and the lower elastic portion 230 protrude rearward to different degrees. It is defined that, one of the upper elastic portion 220 and the lower elastic portion 230 with the rearward-most projection, that is, the one that protrudes further backward, is defined as the first elastic portion, while the other is defined as the second elastic portion. A horizontal projection of the first elastic portion extends rearward beyond a projection of the first vertical portion 210. In the embodiment, preferably, only one of the upper elastic portion 220 and the lower elastic portion 230 protrudes rearward beyond a plane of the first vertical portion 210. A part of a horizontal projection of the second elastic portion overlaps with that of the first vertical portion 210, and the other part located in front of the projection of the first vertical portion 210. Thereof, the upper elastic portion and lower elastic portion are partially offset seen in the upper-lower direction, and one of the upper elastic portion and lower elastic portion straddles the retaining portion, the other of the upper elastic portion and lower elastic portion is located in front of the retaining portion when seen in the upper-lower direction. Preferably, the second elastic portion includes an upright portion 2301 extending vertically from the first vertical portion 210 and is coplanar with the first vertical portion 210, and a bent portion 2302 bending forward from the vertical portion 2301. It should be noted that, in other embodiments, the bent portion 2302 may not be arc-shaped, it is inclined and set an angle to the first vertical portion 210. Preferably, in the embodiment, the upper elastic portion 220 is the first elastic portion with the rearward-most projection, and the lower elastic portion 230 is the second elastic portion. Alternatively, in other embodiments, both the upper elastic portion 220 and the lower elastic portion 230 may protrude rearward beyond the plane of the first vertical portion 210, but the upper elastic portion 220 and the lower elastic portion 230 may have different arcs.

Referring to FIGS. 8-10, in the embodiment, the terminal has only one touching portion 24, and the upper abutting portion 222 and the lower abutting portion 232 abut against an upper face and lower face of the touching portion 24 respectively when the upper elastic arm 22 and the lower elastic arm 23 are pressed. The touching portion 24 extends horizontally forward from the first vertical portion 210 and is formed by cutting and bending from the upper elastic portion 220. Alternatively, in other embodiments, the touching portion 24 may also be formed by cutting and bending from the lower elastic portion 230. In other embodiments, the number of the touching portions 24 may be two. For example, one of the two touching portions is formed by cutting and bending from the upper elastic portion 220, named an upper touching portion, and the other is formed by cutting and bending from the lower elastic portion 230, named a lower touching portion. The upper abutting portion and the lower abutting portion are set at different levels, and the upper abutting portion 222 moves to abut against an upper face of the upper touching portion, and the lower abutting portion 232 moves to abut against a lower face of the lower touching portion.

In the embodiment, the contacting portion and the abutting portion connected to the first elastic portion are defined as a first contacting portion and a first abutting portion, respectively, while the contacting portion and the abutting portion connected to the second elastic portion are defined as a second contacting portion and a second abutting portion. A width of the first contacting portion is equal to that of the second contacting portion. A width of the second abutting portion near the second contacting portion is greater than a width of the first abutting portion near the first contacting portion. Preferably, the first contacting portion is the upper contacting portion 221, and the second contacting portion is the lower contacting portion 231; the first abutting portion is the upper abutting portion 222, and the second abutting portion is the lower abutting portion 232. The upper contacting portion 221 and the lower contacting portion 231 have a same width, and a width of the upper abutting portion 222 near the upper contacting portion 221 is less than that of the lower abutting portion 232 near the lower contacting portion 231. Both the upper elastic portion 220 and the lower elastic portion 230 include a first slot 30. The upper elastic portion 220 forms two spaced first supporting arms 225 via the corresponding first slot 30, and the lower elastic portion 230 forms two spaced second supporting arms 235 via the corresponding first slot 30.

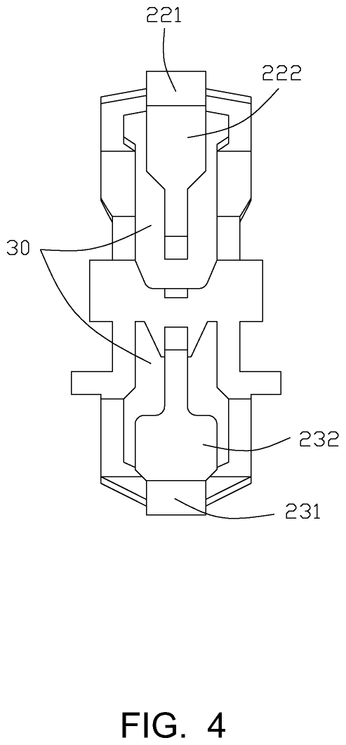

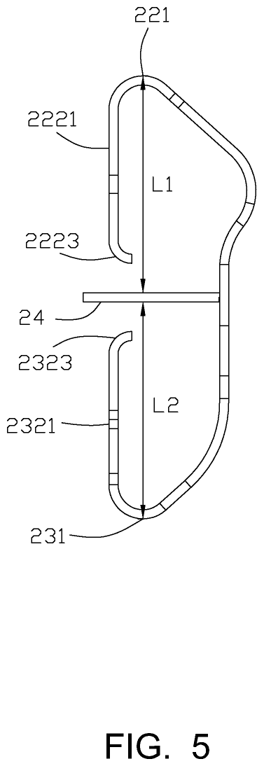

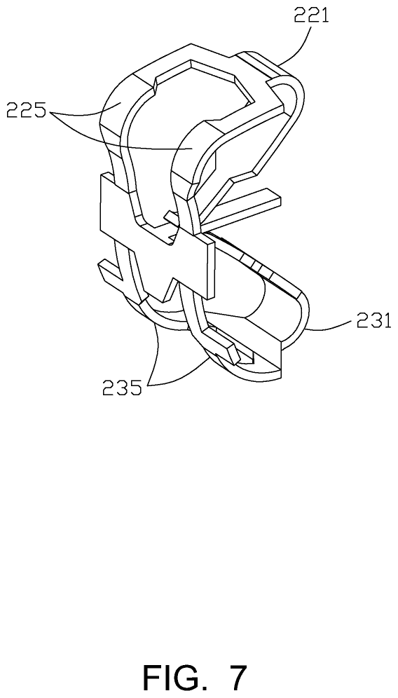

Referring to FIGS. 5-10, in the embodiment, the upper elastic arm 22 sequentially includes the upper elastic portion 220, the upper contacting portion 221, and the upper abutting portion 222. The lower elastic arm 23 sequentially includes the lower elastic portion 230, the lower contacting portion 231, and the lower abutting portion 232. Although the upper elastic portion 220 and the lower elastic portion 230 are not arranged symmetrically in the upper-lower direction, a distance L1 from the upper contacting portion 221 to the upper face of the touching portion 24 is equal to a distance L2 from the lower contacting portion 231 to the lower face of the touching portion 24. The upper abutting portion 222 includes an upper straight arm 2221, and a spoon-shaped contacting end 2223 bending from an end of the upper straight arm 2221 toward the first vertical portion 210. The lower abutting portion 232 includes a lower straight arm 2321 and a spoon-shaped contacting end 2323 that bending from an end of the lower straight arm 2321 toward the first vertical portion 210. Both the upper straight arm 2221 and the lower straight arm 2321are substantially perpendicular to the touching portion 24, and thus, the upper abutting portion 222 and the lower abutting portion 232 can get easily contact with the touching portion 24. Preferably, both the upper straight arm 2221 and the lower straight arm are arranged substantially vertical. The upper straight arm 2221 and the lower straight arm 2321 are located in a same vertical plane. In addition, to facilitate abutment of the upper abutting portions 222 and lower abutting portions 232 with the touching portion 24 when the terminal 20 is pressed, a foremost end of the touching portion 24 extends forward beyond foremost ends of both the upper elastic arm 22 and the lower elastic arm 23, that is, a front end of the touching portion exceeds the upper elastic arm 22 and the lower elastic arm 23 forwardly, and thus, the upper abutting portion 222 moves downward to abut against the upper face of the touching portion 24, and the lower abutting portion 232 moves upward to abut the lower face of the touching portion 24 easily when the upper elastic arm 22 and lower elastic arm 23 are pressed. With further pressing, the upper abutting portion 222 moves rearward along the upper face of the touching portion 24 and the lower abutting portion 232 moves rearward along the lower face of the touching portion 24 respectively to toward the first vertical portion 210. Combined with FIG. 4, in the embodiment, a width of the first slot 30 of the upper elastic portion 220 is greater than a width of the upper abutting portion 222, and a width of the first slot 30 of the lower elastic portion 230 is greater than a width of the lower abutting portion 232, and thus, both the upper abutting portion 222 and the lower abutting portion 232 are exposed to corresponding first slots 30 when viewed from a front-rear direction.

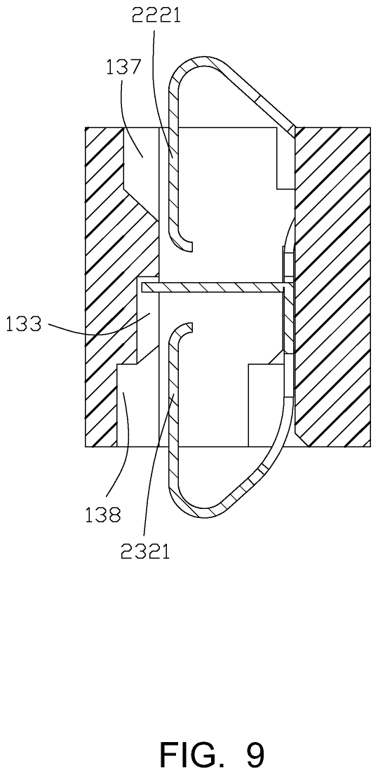

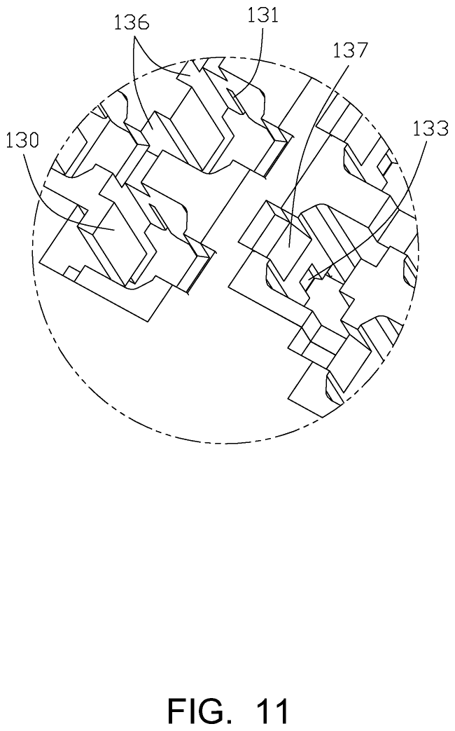

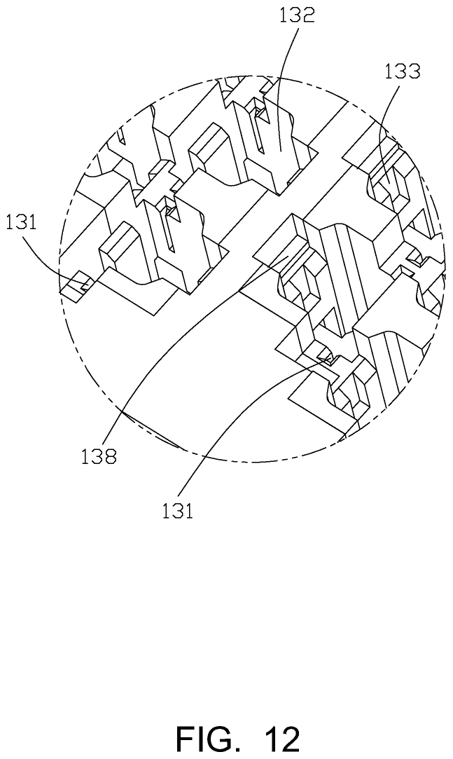

Referring to FIGS. 9-12, the terminal groove 13 includes a retaining slot 131 for receiving the retaining portion 210, a receiving groove 132 communicating with the retaining slot 131 and penetrating the upper face 11 and the lower face of the insulating housing 10 and a blocking groove 133 communicating with the receiving groove 132. The upper and lower elastic arms 22, 23 are located within the receiving groove 132. The touching portion 24 extends forward through the receiving groove 132 and goes into the blocking groove 133 with a front end thereof abutting against an abutting wall 134 of the blocking groove 133. The terminal 20 is inserted into the terminal groove 13 along an inserting direction, and the abutting wall 134 of the blocking groove facing the inserting direction.

In the embodiment, both the blocking groove 133 and the retaining slot 131 open downward, and the terminals 20 are inserted into the terminal grooves 13 from a lower to upper direction. The retaining portions 121 are held within the retaining slots 131 and the front ends of the touching portions 24 abut against corresponding top walls (abutting walls) 134 of the blocking grooves 133 when the terminals are fully inserted, thereby making the terminals 20 stably retained within the terminal grooves 13. Alternatively, in other embodiments, the blocking groove 133 and the retaining slot 131 may open upward, and the terminals 20 can be installed into the terminal grooves 13 from an upper to lower direction. The terminal groove 13 further includes a rib portion 130 protruding forward from a rear wall thereof and two accommodating grooves 136 located at two sides of the rib portion 130 respectively. The rib portion 130 is behind the retaining portion 21. The rib portions 130 go into the slots 30, and the first supporting arm 223 and the second supporting arm 233 are respectively located in the corresponding accommodating grooves 136.

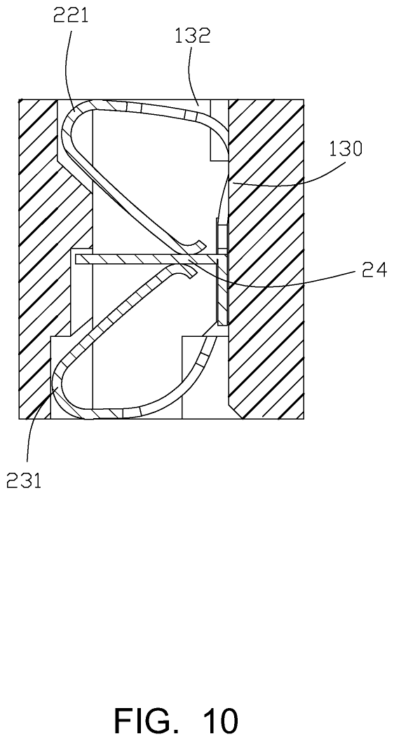

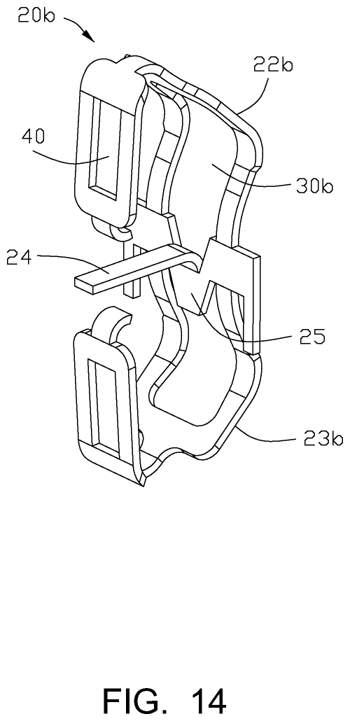

Referring to FIGS. 9-12, the terminal groove 13 also includes an upper avoiding groove 137 and a lower avoiding groove 138 in front of the receiving groove 132 for accommodating the deformed terminal 20 when the terminal is pressed. Preferably, the upper avoiding groove 137 opens upward and the lower avoiding groove 138 opens downward. The blocking groove 133 opens downward and is exposed within the lower avoiding groove 138. Alternatively, the blocking groove may open upward and be exposed within the upper avoiding groove 137. Combined with FIGS. 9-10, both the upper straight arm 2221 and the lower straight arm 2321 are generally vertical, and the upper elastic arm 22 does not go into the corresponding upper avoiding groove 137 and the lower elastic arm 23 does not go into the corresponding lower avoiding groove 138 when the terminal 20 is in a free state. Combined with FIG. 14, the upper elastic arm 22 are partially deformed into the corresponding upper avoiding groove 137 and the lower elastic arm 23 are partially deformed into the corresponding lower avoiding groove 138 when the terminal is pressed. Preferably, the upper contacting portion 221 of the upper elastic arm 22 goes into the corresponding upper avoiding groove 137 and the lower contacting portion 231 of the lower elastic arm 23 goes into the corresponding lower avoiding groove 138 when the upper elastic arm 22 and the lower elastic arm 23 are pressed to deform.

It is noted that, in the embodiment, the upper contacting portion 221 is located between the upper elastic portion 220 and the upper abutting portion 222, and the lower contacting portion 231 is located between the lower elastic portion and the lower abutting portion. Alternatively, the upper abutting portion 222 may be located between the upper elastic portion 220 and the upper contacting portion 221, similarly, the lower abutting portion 232 may be located between the lower elastic portion and the lower contacting portion, just as the upper elastic arms and the lower elastic arms shown in U.S. Pat. No. 10,797,424.

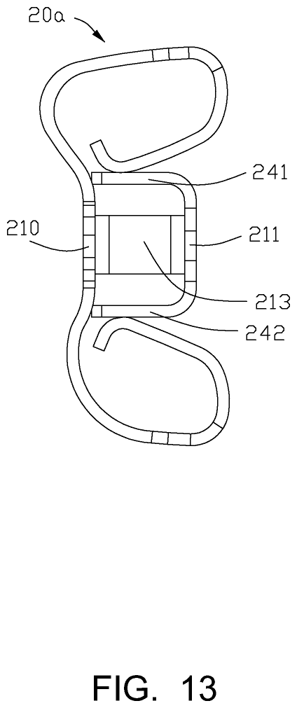

Referring to FIG. 13, a terminal 20a in the second embodiment of the present invention is illustrated. Compared with the terminal 20 in the first embodiment, the difference lies in that the retaining portion 121a of terminal 20a, includes a plate-shaped first vertical portion 210 and a plate-shaped second vertical portion 211 arranged opposite the first vertical portion 210. The first vertical portion 210 and the second vertical portion 211 are connected by a connecting portion 213. In the embodiment, there are two touching portions 24, namely an upper touching portion 241 and a lower touching portion 242. The upper touching portion 241 and the lower touching portion 242 both extend rearward in the horizontal direction from the second vertical portion 211. When the terminal 20a is pressed, the upper elastic arm 22 and the lower elastic arm 23 respectively abut against an upper face of the upper touching portion 241 and a lower face of the lower touching portion 242. Alternatively, in other embodiments, the upper touching portion 241 may be formed by cutting and bending from the upper elastic portion 220 until the first vertical portion 210, and the lower touching portion 242 may be formed by cutting and bending from the lower elastic portion 230. The distance L1 from the upper contacting portion 221 to the upper face of the touching portion 24 is equal to the distance L2 from the lower contacting portion 231 to the lower face of the touching portion 24. Alternatively, in other embodiments, one of the upper touching portion 241 and the lower touching portion 242 may extend horizontally forward from the first vertical portion 210 and the other extends horizontally rearward from the second vertical portion 211. Alternatively, in other embodiments, the touching portion 24 may also be formed by extending from the connecting portion 213, or there may be only one touching portion 24 extending from the second vertical portion 211.

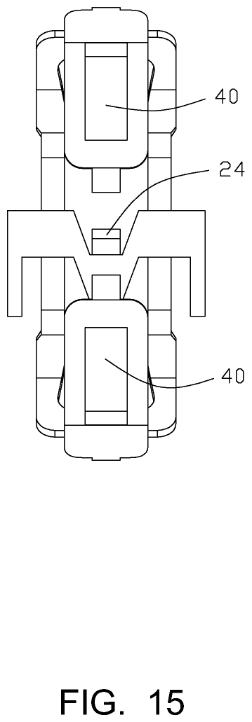

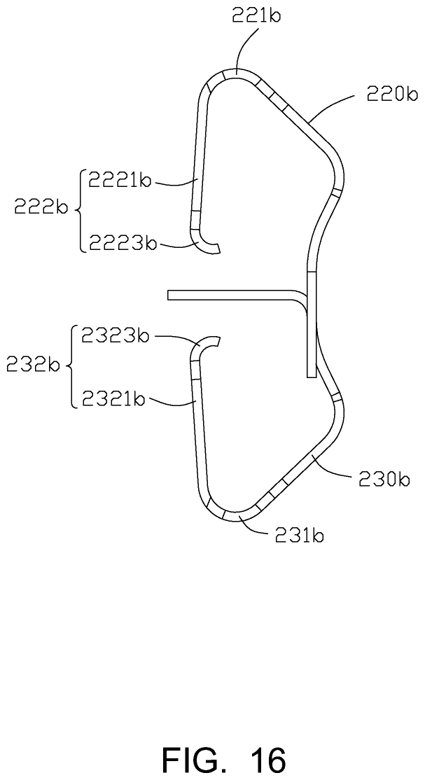

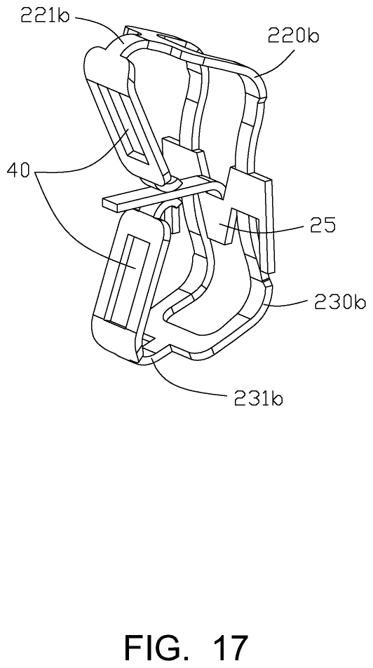

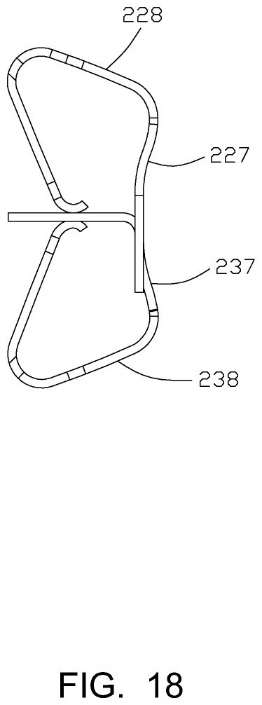

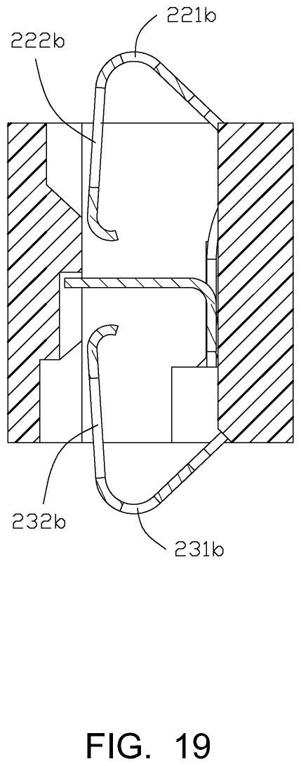

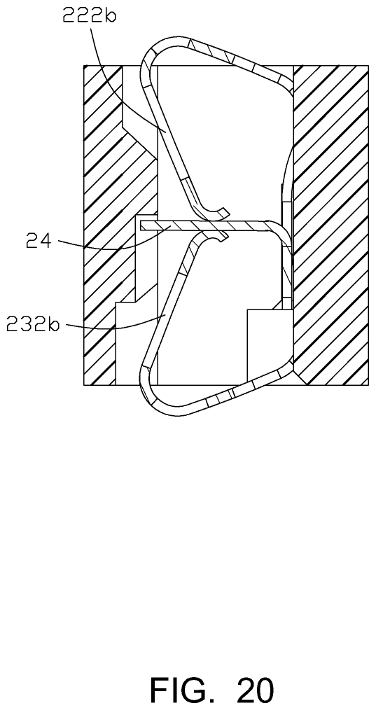

Referring to FIGS. 14-20, a terminal 20b in a third embodiment of the present invention is illustrated. In the embodiment, the upper elastic arm 22b sequentially includes an upper elastic portion 220b, an upper contacting portion 221b and an upper abutting portion 222b. The lower elastic arm 23b sequentially includes a lower elastic portion 230b, a lower contacting portion 231b, and a lower abutting portion 232b. The upper elastic portion 220b and the lower elastic portion 230b each includes a first slot 30b, the upper abutting portion 222b and the lower abutting portion 232b each includes a second slot 40. Similar to the terminals in the first embodiment, the upper abutting portion 222b includes an upper straight arm 2221b arranged substantially vertical, and an upper spoon-shaped contacting end 2223b bending from the upper straight arm 2221b toward the first vertical portion 210. The lower abutting portion 232b includes a lower straight arm 2321b arranged substantially vertical and a lower spoon-shaped contacting end 2323b bending from the lower straight arm 2321b toward the first vertical portion 210. The second slots 40 are respectively positioned on the upper straight arm 2221b and the lower straight arm 2321b. In the embodiment, a width of both the upper straight arm 2221b and the lower straight arm 2321are substantially same with that of the first slot 30b. The touching portion 24 is formed by cutting and bending from a middle portion of the upper elastic portion 220b or the lower elastic portion 230b until the first vertical portion 210, leaving the first slot, that is, the touching portion is formed by bending material corresponding to the first slot of the upper elastic portion or the lower elastic portion, or the touching portion is split the first slot of the upper elastic portion or the lower elastic portion. The upper elastic arm 22b and the lower elastic arm 23b are arranged symmetrically with respect to the touching portion 24 in the upper-lower direction.

In the embodiment, the terminal 20b further includes a tab 25 that also extends from and is coplanar with the first vertical portion 210. The touching portion 24 extends horizontally from the first vertical portion 210 and is formed by cutting from one of the upper elastic portion 220b and the lower elastic portion 230b, and the tab 25 is formed by cutting from the other of the upper elastic portion 220b and the lower elastic portion 230b. Preferably, the touching portion 24 is formed by cutting and bending from the upper elastic portion 220b, and the tab 25 is formed by cutting from the lower elastic portion 230b. Both the upper elastic portion 220b and the lower elastic portion 230b include a rearward inclined portion 227, 237 extending from the first vertical portion 210 and a forward inclined portion 228, 238 extending from the rearward inclined portion 227, 237 respectively. In the embodiment, a height of the tab 25 does not exceed a height of the rearward inclined portion 237.

It should be understood that, in the embodiment, the retaining portion 121b may also be configured to include a second vertical portion, and the touching portion 24 extends from the second vertical portion. Of course, in other embodiments, the touching portion 24 may include an upper touching portion and a lower touching portion. The upper touching portion and the lower touching portion extend from the second vertical portion, or one of upper touching portion and the lower touching portion extend from the first vertical portion and the other extends from the second vertical portion.

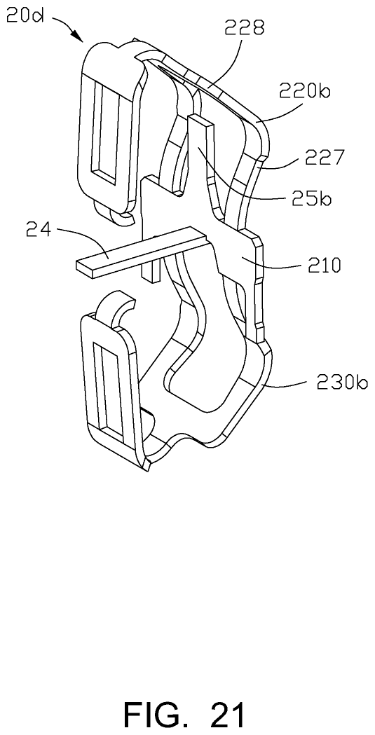

Referring to FIG. 21, a terminal 20d in a fourth embodiment of the present invention is illustrated. The terminal 20d is generally similar to that of the terminal 20b in the third embodiment, the main difference lies in that the touching portion 24 is formed by cutting and bending from the lower elastic portion 230b, while a tab 25d is formed by cutting from the upper elastic portion 220b. A height of a free end of the tab 25b is substantially the same as a height of a junction of the rearward inclined portion 227 and the forwardly inclined portion 228.

It should be particularly noted that, in all the above embodiments of the present invention, the touching portion 24 all extend along the horizontal direction, that is, the axis of the touching portion 24 is parallel to the horizontal axis, and thus, the upper and lower abutting portions 222b, 232b can effectively contact the touching portion 24 when the terminal is pressed. It should be noted that, in other embodiments, the touching portion 24 may also be set at a certain angle with respect to the horizontal direction, for example, the axis of the touching portion 24 may form an angle of 0 to 10 degrees with a horizontal axis, meaning that the touching portion 24 is slightly inclined upward or downward relative to the horizontal direction. The upper touching portion and the lower touching portion may both be slightly inclined downward from a rear to front direction, or one may be slightly inclined downward and the other slightly inclined upward from a rear to front direction when the terminal has two touching portions 24.

Although the present invention has been described with reference to particular embodiments, it is not to be construed as being limited thereto. Various alterations and modifications can be made to the embodiments without in any way departing from the scope or spirit of the present invention as defined in the appended claims.

1. An electrical connector comprising:
an insulating housing having an upper face, a lower face, and a plurality of terminal grooves penetrating the upper face and the lower face in an upper-lower direction; and
a plurality of terminals retained in corresponding terminal grooves respectively;
wherein each terminal comprises a retaining portion fixed in the terminal groove, an upper elastic arm extending upward from the retaining portion and having an arc-shaped upper elastic portion, a lower elastic arm extending downward from the retaining portion and having an arc-shaped lower elastic portion, and a touching portion extending forward from the retaining portion, each of the upper elastic portion and the lower elastic portion has a first slot and arcs backward, the touching portion is split from the first slot of the upper elastic portion or the lower elastic portion, and the upper elastic arm and the lower elastic arm are moveable to abut against the touching portion when the upper elastic arm and the lower elastic arm are pressed.

2. The electrical connector as claimed in claim 1, wherein the retaining portion comprises a first vertical portion, the upper elastic arm extend from an upper edge of the first vertical portion and the lower elastic arm extend from a lower edge of the first vertical portion, the upper elastic portion and lower elastic portion are partially offset seen in the upper-lower direction.

3. The electrical connector as claimed in claim 1, wherein the upper elastic arm sequentially comprises the upper elastic portion, a first contacting portion, and a first abutting portion movable to abut against the touching portion, and the second elastic arm sequentially comprises the lower elastic portion, a lower contacting portion, and a lower abutting portion movable to abut against the touching portion.

4. The electrical connector as claimed in claim 3, wherein the upper abutting portion has an upper straight arm above the touching portion, the lower abutting portion has a lower straight arm below the touching portion, the upper straight arm is substantially perpendicular to the touching portion, and the lower straight arm is substantially perpendicular to the touching portion.

5. The electrical connector as claimed in claim 4, wherein each of the upper abutting portion and the lower abutting portion has a second slot.

6. The electrical connector as claimed in claim 1, wherein one of the upper elastic portion and lower elastic portion straddles the retaining portion and the other of the upper elastic portion and lower elastic portion is located in front of the retaining portion as viewed in the upper-lower direction.

7. The electrical connector as claimed in claim 1, wherein the lower elastic portion comprises an upright portion and a bent portion, the upright portion extends vertically downward from the retaining portion and is coplanar with the retaining portion, and the bent portion bends forward from the upright portion.

8. The electrical connector as claimed in claim 1, wherein the retaining portion is plate-shaped and extends vertically along the upper-lower direction, the touching portion extends horizontally and is perpendicular to the retaining portion.

9. The electrical connector as claimed in claim 1, wherein a foremost end of the touching portion extends forward beyond foremost ends of the upper elastic arm and the lower elastic arm.

10. An electrical connector comprising:
an insulating housing having an upper face, a lower face, and a plurality of terminal grooves penetrating the upper face and the lower face in an upper-lower direction; and
a plurality of terminals retained in corresponding terminal grooves respectively, each terminal comprising a plate-shaped retaining portion fixed in the terminal groove, an upper elastic arm extending upward from the retaining portion and having an arc-shaped upper elastic portion, a lower elastic arm extending downward from the retaining portion and having an arc-shaped lower elastic portion, an upper touching portion, and a lower touching portion;
wherein each of the upper elastic portion and the lower elastic portion arches backward, the upper touching portion is split from the upper elastic portion and bends forwards, the lower touching portion is split from the lower elastic portion and bends forwards, the first elastic arm is movable to abut against an upper face of the upper touching portion, and the lower elastic arm is movable to abut against a lower face of the lower touching portion.

11. The electrical connector as claimed in claim 10, wherein the upper touching portion and the lower touching portion are perpendicular to the retaining portion.

12. An electrical connector comprising:
an insulating housing having an upper face, a lower face, and a plurality of terminal grooves penetrating the upper face and the lower face in an upper-lower direction; and
a plurality of terminals retained in corresponding terminal grooves respectively, each terminal comprising a retaining portion fixed in the terminal groove, an upper elastic arm extending upward from the retaining portion, a lower elastic arm extending downward from the retaining portion, and a touching portion extending forward from the retaining portion;
wherein the upper elastic arm sequentially comprises an arc-shaped upper elastic portion and arching backward and then forwards, an upper contacting portion, and an upper abutting portion, and the lower elastic arm sequentially comprises an arc-shaped lower elastic portion and arching backward, a lower contacting portion, and a lower abutting portion, a projection of one of the upper elastic portion and the lower elastic portion in a horizontal direction exceeds backward a projection of the other of the upper elastic arm and the lower elastic arm, and the upper abutting portion is movable to abut against an upper face of the touching portion and the lower abutting portion is movable to abut against a lower face of the touching portion when the upper elastic arm and the lower elastic arm are pressed.

13. The electrical connector as claimed in claim 12, wherein the upper abutting portion comprises an upper straight arm and an upper spoon-shaped contacting end, the lower abutting portion comprises a lower straight arm and a lower spoon-shaped contacting end, and the upper straight arm and the lower straight are substantially perpendicular to the touching portion.

14. The electrical connector as claimed in claim 13, wherein a distance from the upper contacting portion to the upper face of the touching portion is equal to a distance from the lower contacting portion to the lower face of the contacting portion.

15. The electrical connector as claimed in claim 12, wherein the touching portion extends along a direction with an axis thereof forming an angle of 0 to 10 degrees relative to a horizontal axis.

16. The electrical connector as claimed in claim 12, wherein retaining portion is plate-shaped, and the touching portion is split from the upper elastic portion or the lower elastic portion.

17. The electrical connector as claimed in claim 12, wherein a front end of the touching portion exceeds the upper elastic arm and the lower elastic arm forwardly.

18. The electrical connector as claimed in claim 12, wherein each of the upper elastic portion and the lower elastic portion has a first slot.
